(19) United States
(12) Patent Application Publication
(10) Pub. No.: US 2015/0218879 A1
(43) Pub. Date: Aug. 6, 2015

(54) END CAP FOR A RAIL FOR A WINDOW COVERING

(71) Applicant: Hunter Douglas Inc., Pearl River, NY (US)

(72) Inventor: Richard N. Anderson, Whitesville, KY (US)

(73) Assignee: HUNTER DOUGLAS INC., Pearl River, NY (US)

(21) Appl. No.: 14/685,646

(22) Filed: Apr. 14, 2015

Related U.S. Application Data
(63) Continuation-in-part of application No. 14/089,861, filed on Nov. 26, 2013.
(60) Provisional application No. 61/873,055, filed on Sep. 3, 2013.
(60) Provisional application No. 61/734,048, filed on Dec. 6, 2012.

(51) Int. Cl. E06B 9/17; E06B 9/42; E06B 9/388

(52) U.S. Cl. CPC E06B 9/17076; E06B 9/388; E06B 9/42; E06B 9/17007; E06B 2009/17084

(57) ABSTRACT

An end cap for use on a rail for a covering for an architectural opening. At least one securement leg secures the end cap to the rail.

This application is a continuation-in-part of U.S. application Ser. No. 14/089,861, filed Nov. 26, 2013, which claims priority from Ser. No. 61/873,055, filed Sep. 3, 2013 and 61/734,048, filed Dec. 6, 2012, all of which are incorporated herein by reference.

### BACKGROUND

The present invention relates to an end cap for use on a rail for a window covering. More specifically, it relates to a removable end cap with a bias to ensure a tight fit against the end of the rail.

In typical prior art end caps, securement means such as crush ribs have been used to ensure a tight fit against the end of a rail. While this is effective for single use applications, if the end cap needs to be removed, it usually is not possible to reuse the end cap and still have a tight fit that will ensure the end cap will not fall out.

### SUMMARY

In one embodiment of the present invention, an end cap mounting arrangement is provided with the end cap having an arcuate cross-sectional shape which is flattened when the end cap is installed, creating a bias, which results in a releasable, reusable end cap with a tight fit against the end of a rail.

### BRIEF DESCRIPTION OF THE DRAWINGS

FIG. 1 is a perspective view of a window covering including a head rail, a pleated shade portion, an intermediate rail, a cellular shade portion, and a bottom rail;

FIG. 2 is a perspective view of the intermediate rail and end cap of FIG. 1, with the rail broken away;

FIG. 3 is a section view along line 3-3 of FIG. 2;

FIG. 4 is a perspective view of the assembled rail and end cap of FIG. 2, with the rail broken away and with the projection on the beam of the end cap and the corresponding through opening in the rail shown in phantom;

FIG. 5 is the same view as FIG. 4, but removing the phantom lines;

FIG. 6 is a broken away front view of the rail and end cap of FIG. 2 with the end cap aligned with the rail in preparation for installation onto the rail;

FIG. 7 is the same view as FIG. 6 but with the end cap partially installed onto the rail;

FIG. 8 is the same view as FIG. 7 but with the end cap fully installed onto the rail;

FIG. 9 is a view from the bottom, looking up, of the rail and end cap of FIG. 6;

FIG. 10 is a view from the bottom, looking up, of the rail and end cap of FIG. 7;

FIG. 11 is a view from the bottom, looking up, of the rail and end cap of FIG. 8;

FIG. 12 is a view taken along the section 12-12 of FIG. 4;

FIG. 13 is the same as FIG. 12 but for an alternative embodiment;

FIG. 14 is the same as FIG. 12 but for another alternative embodiment;

FIG. 15 is a perspective view of a rail and end cap for yet another alternative embodiment, with the rail broken away;

FIG. 16 is a perspective view of the assembled rail and end cap of FIG. 15, with the rail broken away;

FIG. 17 is a broken away front view of the rail and end cap of FIG. 15 with the end cap aligned with the rail in preparation for installation onto the rail;

FIG. 18 is the same view as FIG. 17 but with the end cap partially installed onto the rail;

FIG. 19 is the same view as FIG. 18 but with the end cap fully installed onto the rail;

FIG. 20 is a view from the bottom, looking up, of the rail and end cap of FIG. 17;

FIG. 21 is a view from the bottom, looking up, of the rail and end cap of FIG. 18;

FIG. 22 is a view from the bottom, looking up, of the rail and end cap of FIG. 19;

FIG. 23 is a section view along line 23-23 of FIG. 16, with a top plate added to close up the top opening of the rail so as to hide any mechanism housed inside the rail;

FIG. 24 is a perspective view of a rail and end cap for another alternative embodiment, with the rail broken away;

FIG. 25 is a perspective view of the assembled rail and end cap of FIG. 24, with the rail broken away;

FIG. 26 is a section view along line 26-26 of FIG. 25;

FIG. 27 is a plan view of the end cap of FIG. 24;

FIG. 28 is a perspective view of a rail and end cap for another alternative embodiment, with the rail broken away;

FIG. 29 is a perspective view of the assembled rail and end cap of FIG. 28, with the rail broken away; and

FIG. 30 is a plan view of the end cap of FIG. 28.

### DESCRIPTION

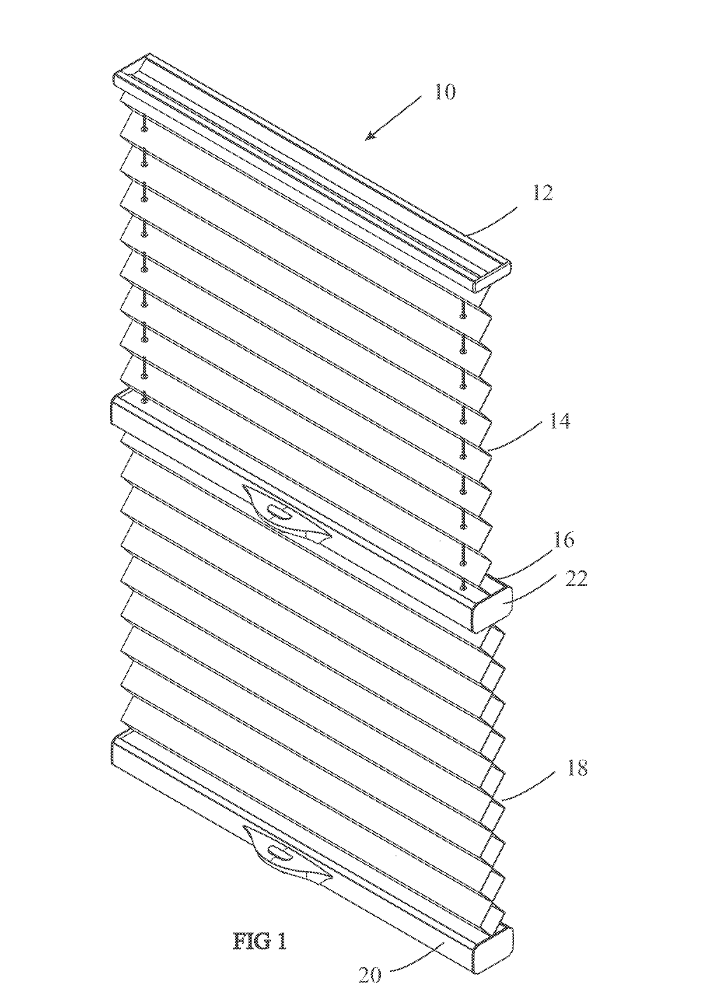

FIG. 1 shows a window covering 10 including a head rail 12, a pleated shade portion 14, an intermediate rail 16, a cellular shade portion 18, and a bottom rail 20. Any one of the rails 12, 16, 20 (or all three of the rails) may house components (not shown) to assist the user in raising or lowering the window covering 10. The rails 12, 16, 20 are elongated and include end caps, such as the end cap 22 on the intermediate rail 16, which provide a pleasing, aesthetic finish to the rail 16, and provide access to any components housed in the rail 16 during assembly of the window covering 10 and also later on, during adjustment or replacement of the components housed in the rail 16. Of course, other types of window coverings, such as Venetian blinds, also have rails with end caps and may use the end cap mounting arrangement of this invention.

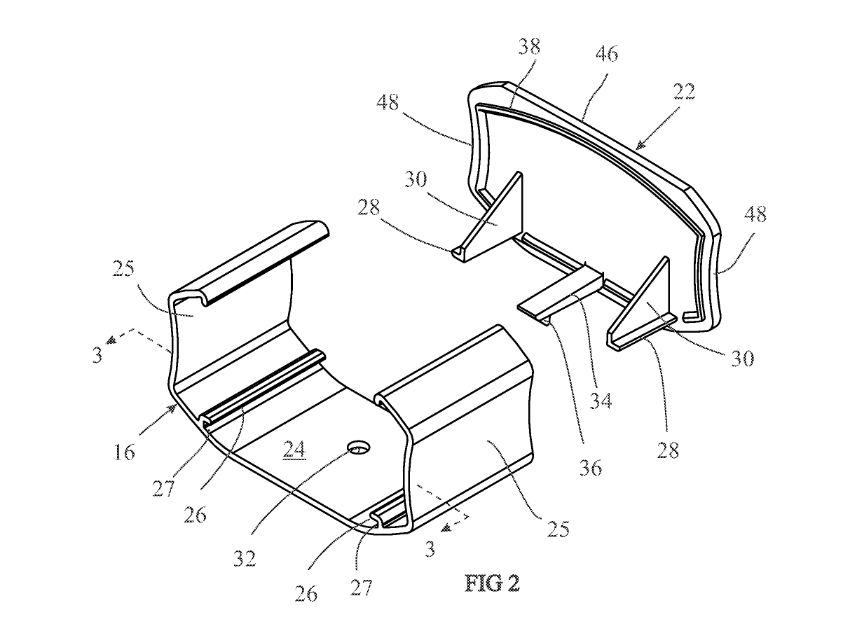

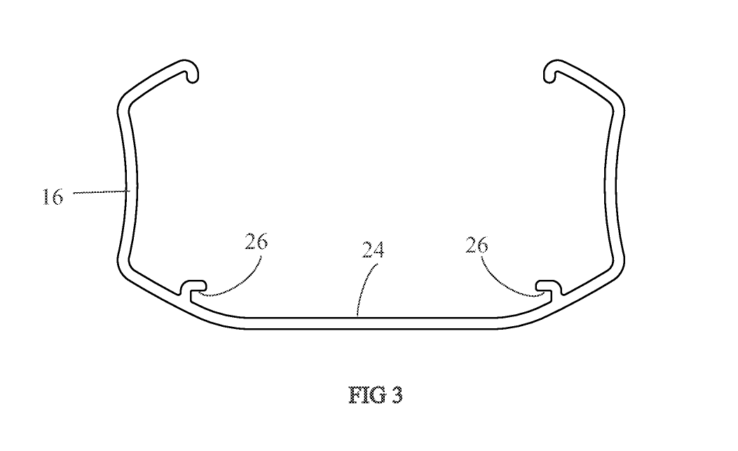

FIGS. 2-11 show the end cap 22 and rail 16 of FIG. 1 in more detail. Referring to FIGS. 2 and 3, the rail 16 has a “U”-shaped profile including an elongated base wall 24 and two elongated legs 25 projecting away from the base wall 24. The end of the rail 16 is flat, lying in a vertical plane. Two opposed tracks 26 project away from the inner surface of the base wall 24. These tracks 26 extend parallel to the longitudinal axis of the rail 16 and are designed and sized to slidingly receive mating wings 28 on corresponding outriggers 30 projecting from the inner surface of the end cap 22. The tracks 26 have a hook-shaped cross-section, projecting away from the base wall 24 and then inwardly, toward the central axis of the rail 16, forming a space 27 between the inwardly projecting portion and the base wall 24. The mating wings 28 project outwardly, away from the central axis of the rail 16, and are received in the respective spaces 27 formed by the tracks 26.

The rail 16 also defines an opening 32 through the base wall 24 of the rail 16. The opening 32 is located between the tracks 26 near the end of the rail 16.

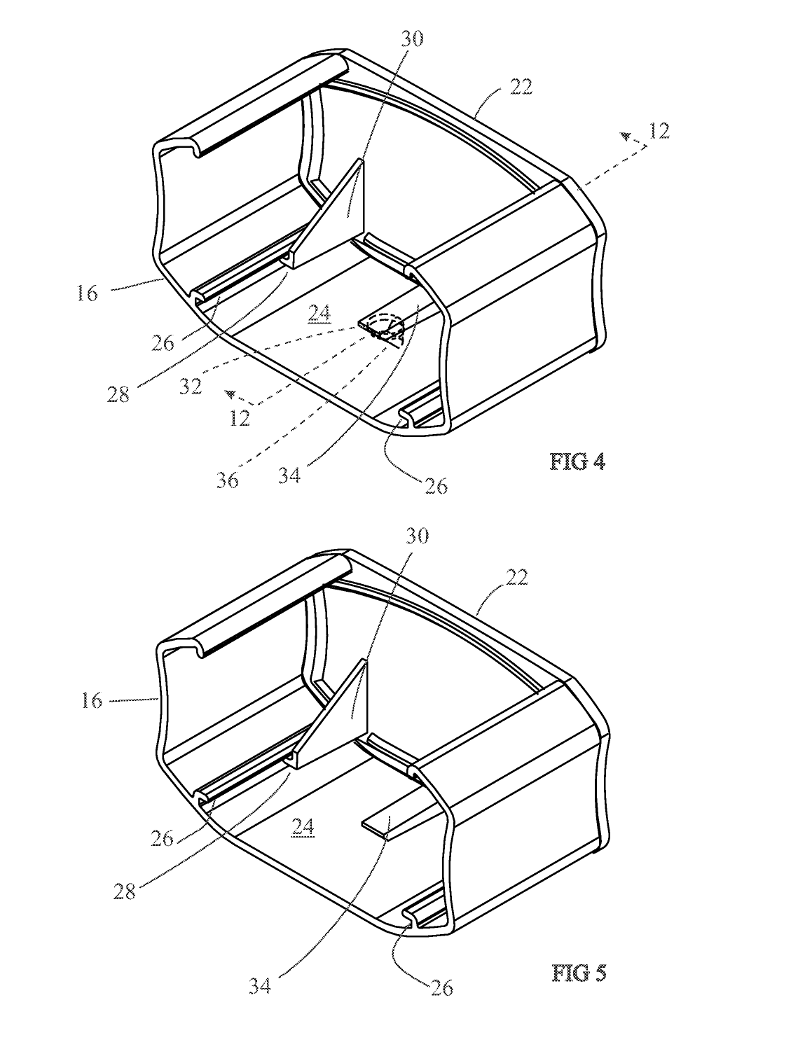

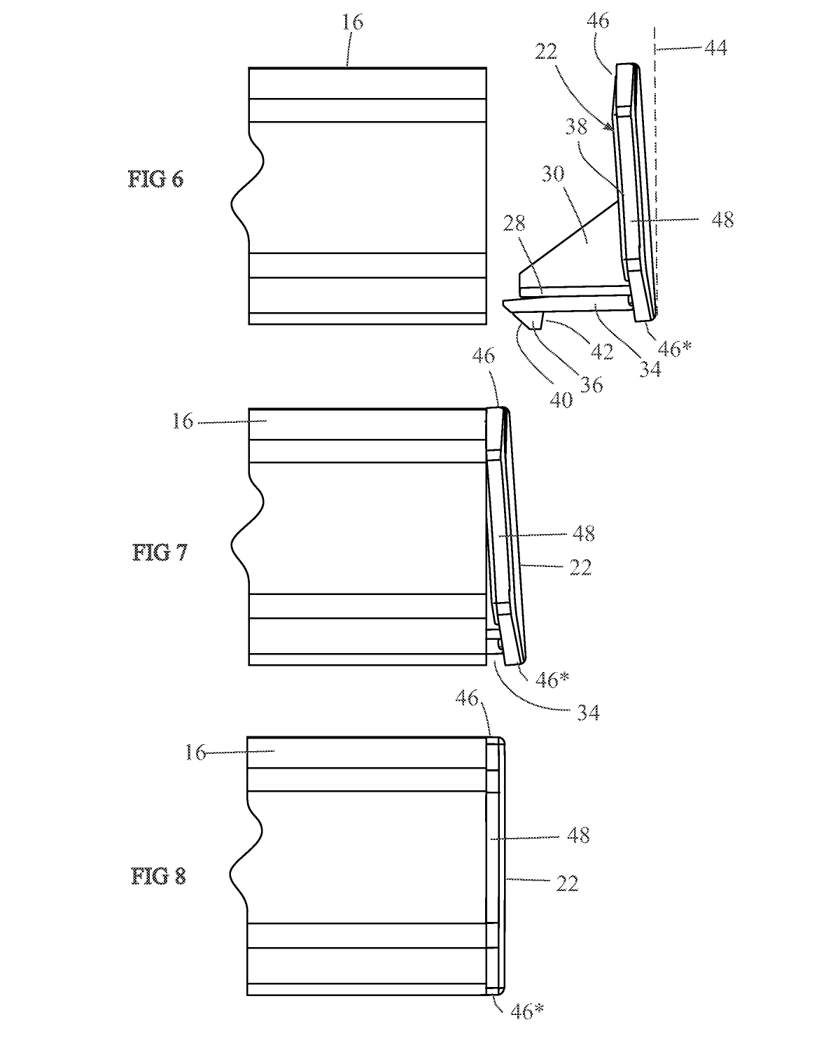

In addition to the previously described outriggers 30, a beam 34 projects from the inner surface of the end cap 22 in a horizontal direction substantially parallel to the wings 28 (See also FIG. 6). A projection 36 extends from the free end of the beam 34 toward the base wall 24. The projection 36 is sized and located such that it is received in the opening 32 in the rail 16 when the end cap 22 is snapped onto the rail 16, as described later. The projection 36 defines a sloped leading surface 40 (See FIG. 6) to ease the beam 34 onto the base wall 24 of the rail 16, and a slightly tapered shoulder 42 on the opposing surface of the projection 36 to pull the end cap 22 into the rail 16 and to lock the projection 36 into the opening 32 (See also FIGS. 4 and 5).

The end cap 22 also includes an inwardly-projecting, discontinuous flange 38 extending along substantially the entire perimeter of the end cap 22 and spaced inwardly a short distance from the perimeter. This flange 38 fits inside the end of the rail 16, with the first and second opposed edges 48 and the third and fourth opposed edges 46, 46* of the end cap 22 abutting the end of the rail 16. The flange 38 provides a light stop to prevent light from passing completely through any small gaps that may exist between the end cap 22 and the end of the rail 16.

Referring to FIG. 6, the dotted vertical line 44 is perpendicular to the horizontal direction of the wings 28. It may be appreciated that the top edge 46 of the end cap 22 lies slightly forward of the dotted line 44, while the bottom edge 46* lies on the dotted line 44. As the end cap 22 is installed onto the rail 16 by sliding the wings 28 horizontally into the tracks 26 and pushing the end cap 22 against the rail 16 (See FIG. 7), the top edge 46 of the end cap 22 impacts first against the end of the rail 16. The end cap 22 is then pushed further into the rail 16 until the projection 36 on the beam 34 snaps into the opening 32 in the base wall 24 of the rail 16, which also coincides with the position where the end cap 22 fits tightly against the rail 16, as shown in FIG. 8. The wall 42 of the projection 36 abuts the wall of the opening 32, which is fixed relative to the rail 16, so the wall of the opening 32 serves as a retaining wall, providing a positive stop that prevents the end cap 22 from being pulled back out of the rail 16. The scale is distorted and the distance that the end cap 22 is pushed into the rail 16 between FIGS. 7 and 8 is exaggerated to illustrate the point.

It should be noted that the wall 42 of the projection 36 is slightly tapered relative to the wall of the opening 32, so that the beam 34 pulls the end cap 22 further toward the rail 16 as the projection 36 moves further into the opening 32.

In order to move the end cap from the position shown in FIG. 7 to the position shown in FIG. 8, the end cap pivots about the top edge 46 relative to the rail 16. This causes the wings 28 to push upwardly against the bottom surface of their respective tracks 26, which are fixed relative to the rail 16, wedging the wings 28 against the tracks 26. Even though the actual horizontal distance traveled is small, it is enough to wedge the wings 28 against their corresponding tracks 26 for a tight fit between the end cap 22 and the rail 16 and creates a tension in the end cap 22 which retains the end cap 22 on the rail 16 (See FIG. 8).

The beam 34 also exerts a downward force on the base wall 24 of the rail 16, which lifts the wings 28 upwardly against the tracks 26.

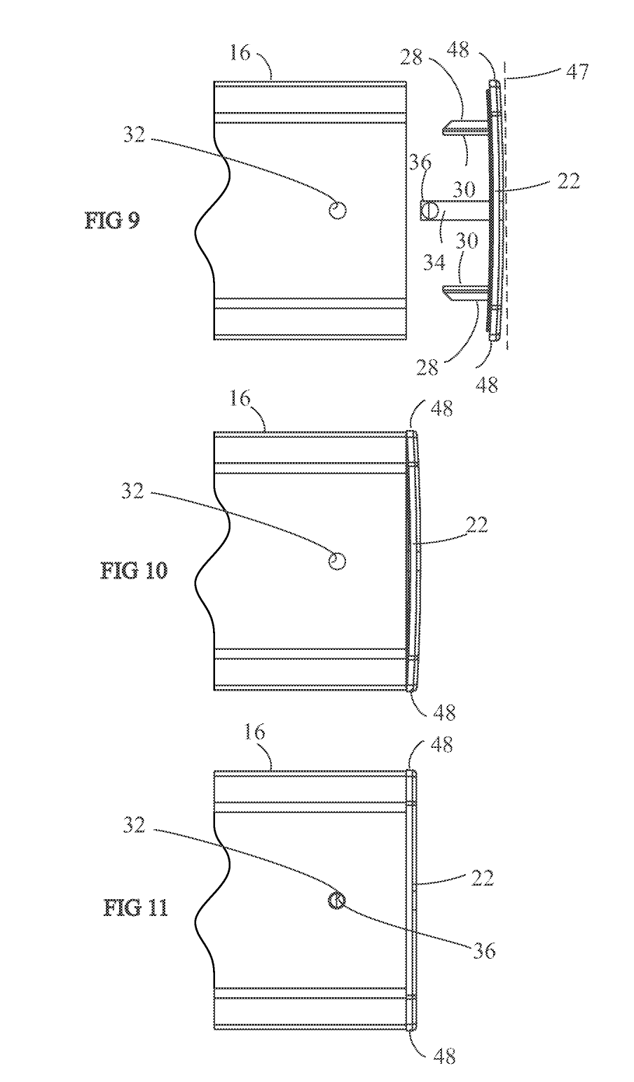

Referring to FIG. 9, the dotted line 47 shows that, when at rest, the end cap 22 has a slightly arcuate shape. The front and rear edges (first and second opposed edges) 48 of the end cap 22 are located slightly inwardly, away from the dotted line 47 and toward the rail 16, and the central portion of the end cap 22, located between the opposed edges 48, is located further away from the rail 16. As the end cap 22 is installed onto the rail 16 by sliding the wings 28 into the tracks 26 and pushing the end cap 22 against the rail 16 (See FIG. 10), the edges 48 of the end cap 22 impact against the rail 16. The installer continues pushing the end cap 22 toward the rail 16, flattening the curvature of the end cap 22 until the projection 36 on the beam 34 snaps into the opening 32 in the base wall 24 of the rail 16, which also coincides with the position where the end cap 22 is flattened and fits tightly against the rail 16, as shown in FIG. 11.

Referring again to FIGS. 8 and 11, with the end cap 22 installed onto the rail 16, it may be appreciated that the end cap 22 lies flat against the end of the rail 16 and no longer displays the slight curvature or slanting away from either of the axes 44 and 47.

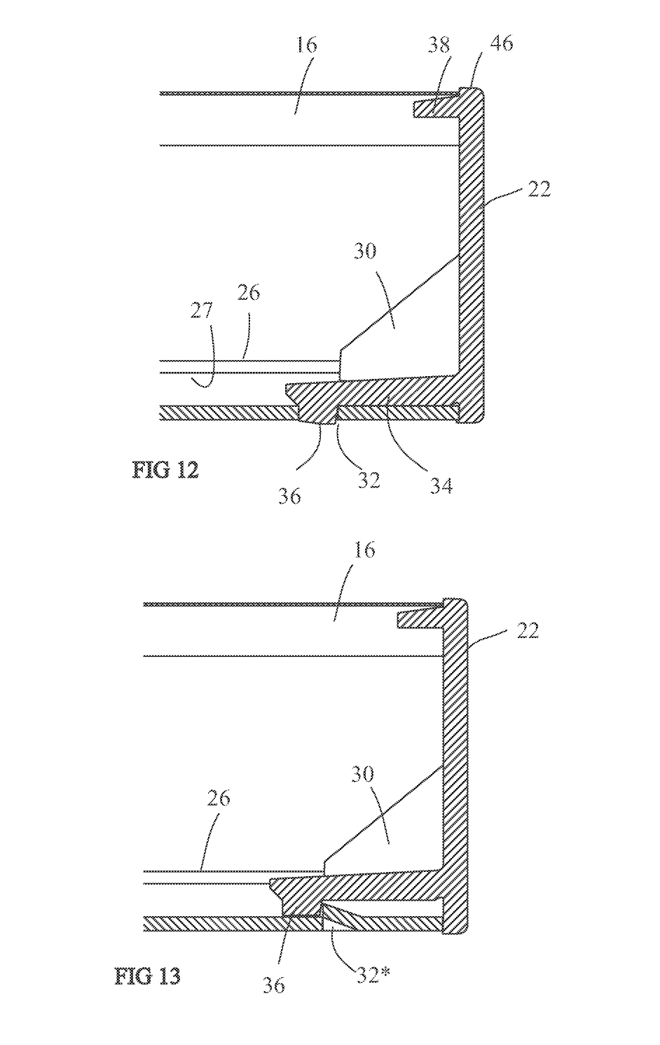

As the end cap 22 is pushed inwardly into the end of the rail 16, the projection 36 on the beam 34 riding on the base wall 24 of the rail 16 causes the beam 34 to flex upwardly. As the projection 36 on the beam 34 slides past the vertical edge of the opening 32 on the base wall 24 of the rail 16, the beam 34 snaps back downwardly, and the projection 36 abuts the edge of the opening 32 (the retaining wall), providing a positive stop that secures the projection 36 in the opening 32. The beam 34 serves as a securement leg to keep the end cap 22 secured onto the rail 16 in a flattened condition. The wings 28 wedged in the tracks 26 also are abutting surfaces fixed relative to the rail 16 (i.e. the tracks 26) and serve as securement legs to keep the end cap 22 pulled snugly against the end of the rail 16 in a flattened condition. These securement legs 34, 28 act against the bias of the flattened end cap 22, which wants to return to its original, arcuate shape. The securement legs 34, 28 hold the end cap 22 tightly to the rail 16, under tension provided by the spring action of the flattened end cap 22. FIG. 12 shows the projection 36 on the beam 34 abutting the edge of the opening 32, which serves as a retaining wall.

To remove the end cap 22 from the rail 16, the user pushes upwardly on the projection 36 on the beam 34 until it clears the base wall 24 of the rail 16, and then grasps the end cap 22 and pulls outwardly. Once the projection 36 has cleared the opening 32, the end cap 22 may be pulled straight out. The end cap 22 may be reinstalled over and over again with no detrimental effect on its performance.

While this description refers to top, bottom, front and rear, it is understood that the rail 16 could be rotated so that the base wall 24, which is shown in this embodiment as being located at the bottom, becomes the front wall or the rear wall or the top wall, and the directions of the corresponding elements would change accordingly.

An alternative embodiment, shown in FIG. 13, is the same as the embodiment described above except that, instead of the opening 32, there is a body 32* projecting upwardly from the base wall 24 of the rail 16 in the same position as the opening 32. The body 32* has a vertical wall on an inner side, which is fixed relative to the rail 16 and serves as a retaining wall, such that, when the projection 36 passes over the body 32*, the projection 36 abuts the retaining wall on the body 32*, thereby having the same effect of providing a positive stop to secure the beam 34 in position on the rail 16. As was noted in the previous embodiment, there is a slight angle between the wall of the projection 36 and the abutting retaining wall, so that the beam 34 pulls the end cap 22 toward the end of the rail 16 as the projection 36 moves downwardly into the retaining wall on the body 32*.

While the body 32* in this embodiment is formed as part of the rail 16, it alternatively could be a separate member secured to the rail 16, in which case its retaining wall still would be fixed relative to the rail 16.

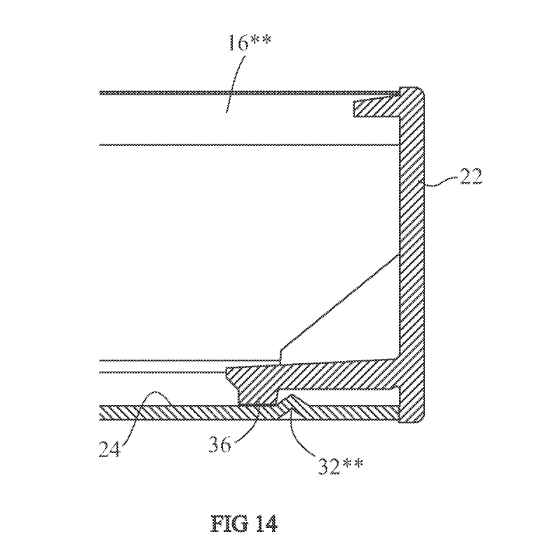

Another alternative embodiment shown in FIG. 14 includes a rail 16** which has a bump 32** (instead of an opening 32) formed on the base wall 24. The projection 36 passes over the bump 32**, which is a body projecting from the rail that provides an abutting retaining wall which is at an angle to the vertical. This angled retaining wall also causes the projection 36 to pull the end cap inwardly, toward the rail as the projection 36 passes over the bump 32**.

Another alternative embodiment (not shown) is the same as the first embodiment except that it has no opening 32 or body 32* on the rail 16 but simply relies upon the wedging of the beam 34 pushing downwardly on the base wall 24 and of the wings 28 pushing upwardly on the tracks 26 to secure the end cap on the rail 16 against the biasing force of the flattened end cap 22 which wants to return to its arcuate shape. This alternative embodiment has the advantage that no holes (such as the hole 32 of FIG. 12) or discontinuities (such as the dimple 32* or 32** of FIGS. 13 and 14 respectively) are seen by the user on the rail 16.

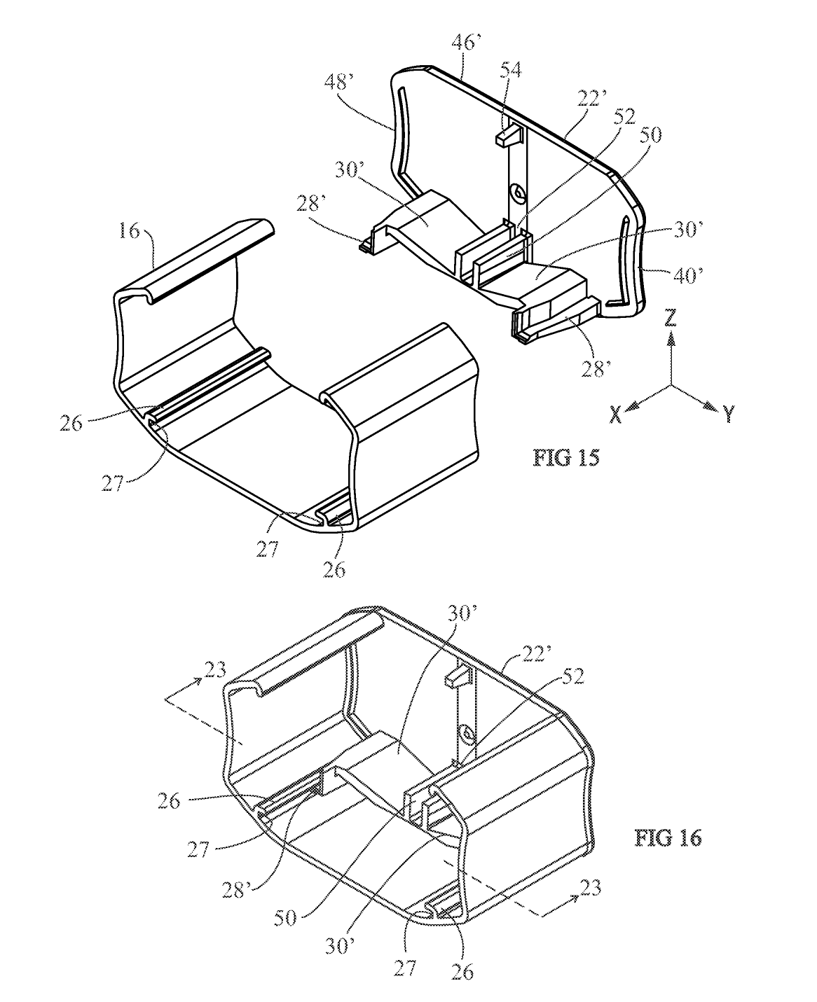

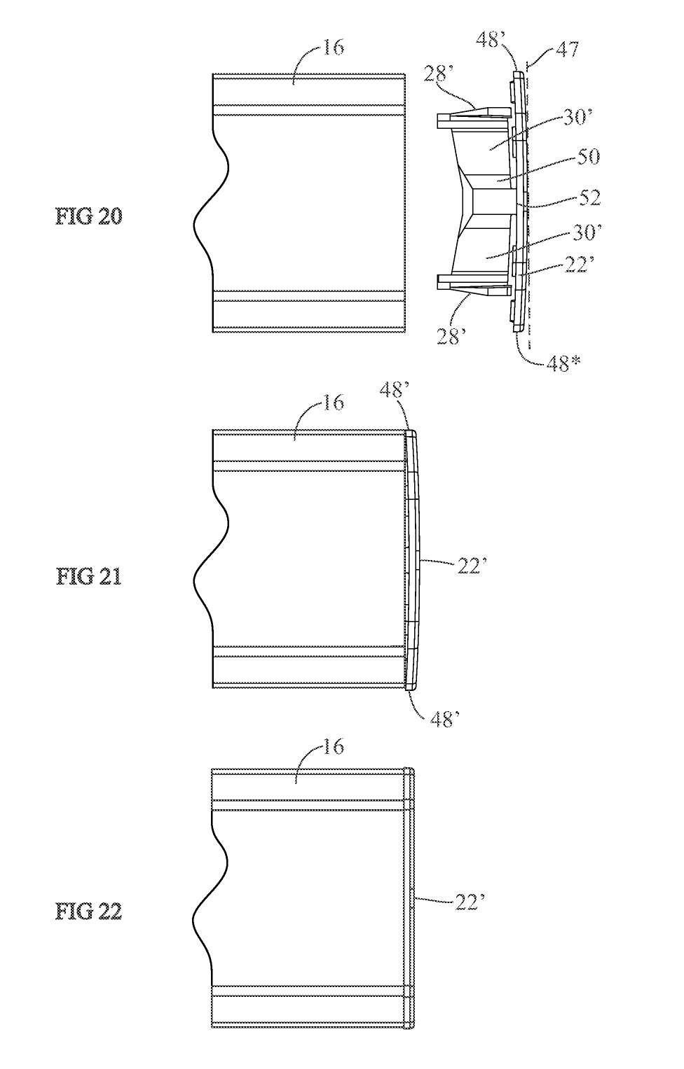

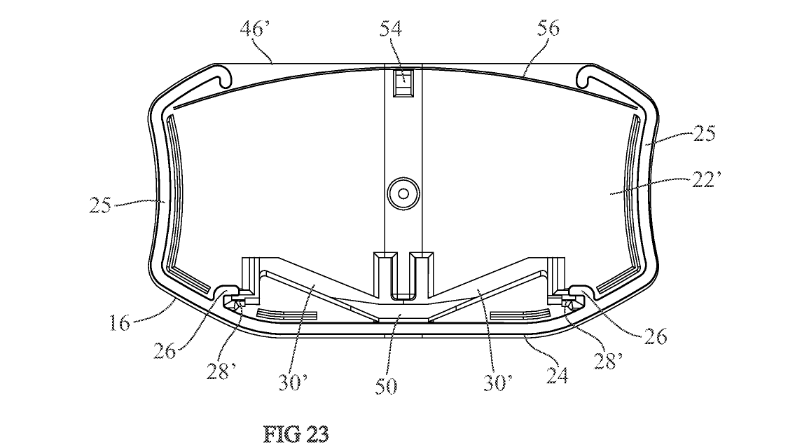

FIGS. 15-23 show another embodiment of an end cap 22′ and rail 16. The rail 16 is identical to the rail 16 described above except that there is no need for an opening 32 or bump 32**. The end cap 22′ is similar to the end cap 22 of FIG. 2 in that it has wings 28′ distally mounted on outriggers 30′. However, in this embodiment, as best appreciated in FIG. 20, the outriggers 30′ are not in contact with the end plate 22′ but instead are cantilevered off of a beam 50 which is centrally connected along beam portions 52 to the end plate 22′. This allows the outriggers 30′ to rotate slightly in the “z” direction (in the vertical direction, See FIG. 15) relative to the beam 50 and relative to the end plate 22′. This, in turn, permits the wings 28′ to float up or down relative to the beam 50 as required. In this arrangement, the outriggers 30′ and beam 50 form an “M” shaped profile, as best appreciated in FIG. 23, with the wings 28′ projecting outwardly from the free ends of the “M”.

As shown in FIG. 23, the beam 50 pushes against the bottom of the rail 16 when the end cap 22′ is installed on the rail 16, serving as a securement leg, and the outwardly projecting wings 28′ are received in the spaces 27 formed between the tracks 26 and the bottom surface of the rail 16, so each of the wings 28′ (together with its respective outrigger 30′) also serves as a securement leg. As the wings 28′ engage the tracks 26, the wings 28′ are wedged against the tracks 26 and are squeezed together, toward each other, in a squeezing direction. Squeezing the wings 28′ together in this particular geometry lifts the beam 50 and the end cap 22′ relative to the base of the rail 16 (i.e. moves the end cap in a direction perpendicular to the squeezing direction).

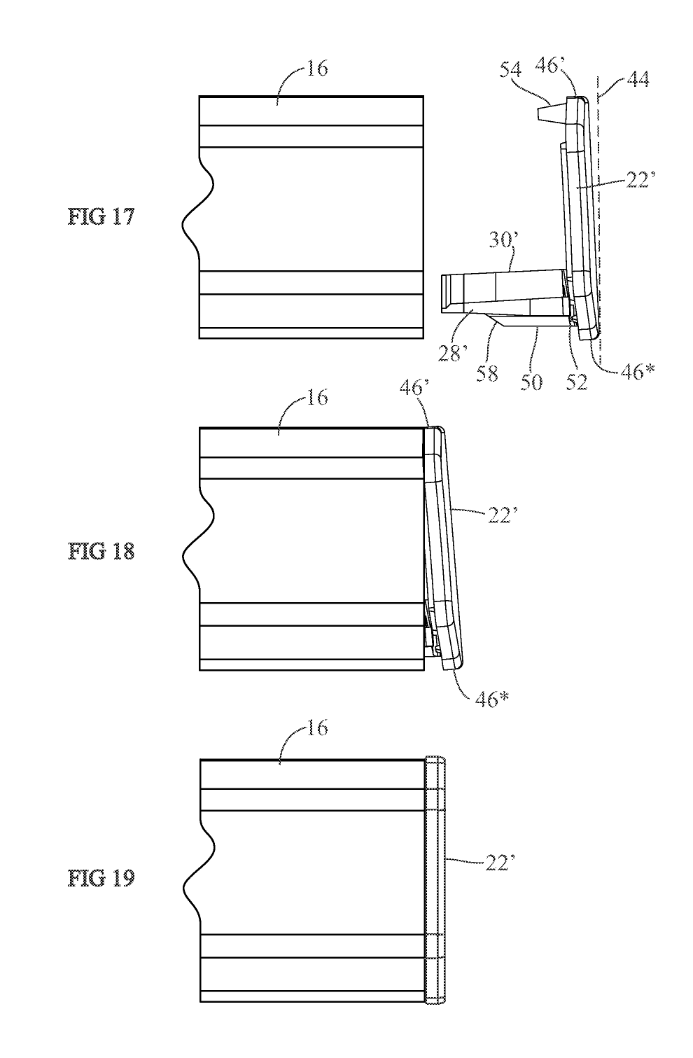

As shown in FIG. 17, the beam 50 has a tapered front edge 58, which eases the beam 50 into the inside of the rail 16.

The wings 28′ are parallel to each other and are mirror images of each other. As shown in FIG. 15, the wings 28′ are tapered in both the “x” and “z” directions, which helps the wings 28′ enter into the spaces 27 beneath and between the tracks 26 and helps cause the deflection of the outriggers 30′. As shown in FIG. 17, the top surfaces of the wings 28′ are at a lower elevation at the end directed toward the rail 16 and taper to a higher elevation at the end adjacent to the end cap 22′. As shown in FIG. 15, the outer surfaces of the wings 28′ are closer together at the end directed toward the rail 16 and taper further outwardly in the “y” direction as they approach the end cap 22′, which helps the wings 28′ enter easily into the spaces 27 beneath and between the tracks 26.

Referring to FIG. 17, the dotted vertical line 44 is perpendicular to the horizontal direction of the wings 28′. It may be appreciated that the top edge 46′ of the end cap 22 lies slightly forward of the dotted line 44, while the bottom edge 46* lies on the dotted line 44. As the end cap 22′ is installed onto the rail 16 by sliding the wings 28′ horizontally into the tracks 26 and pushing the end cap 22′ against the rail 16, the top edge 46′ of the end cap 22′ impacts first against the end of the rail 16, as shown in FIG. 18. The end cap 22′ is then pushed further into the rail 16 until the end cap 22′ fits tightly against the rail 16, with all four edges of the end cap abutting the flat end of the rail, as shown in FIG. 19.

In order to move the end cap 22′ from the position shown in FIG. 18 to the position shown in FIG. 19, the end cap 22′ pivots about the top edge 46′ relative to the rail 16. This pivoting causes the wings 28′ to wedge tightly into the space 27 between the tracks 26 and the rail 16 such that the end cap 22′ is held snugly against the rail 16 and cannot accidentally be pried off. Thus, the wings 28′ serve as securement legs.

Referring to FIG. 20, the dotted line 47 shows that, when at rest, the end cap 22′ has a slightly arcuate shape. The front and rear edges (first and second opposed edges) 48′ of the end cap 22′ are located slightly inwardly, away from the dotted line 47 and toward the rail 16, and the central portion of the end cap 22′, located between the opposed edges 48′, is located further away from the rail 16. As the end cap 22′ is installed onto the rail 16 by sliding the outwardly projecting wings 28′ under the tracks 26 and pushing the end cap 22′ against the rail 16, the front and rear edges 48′ of the end cap 22′ impact against the rail 16, as shown in FIG. 21. The installer continues pushing the end cap 22′ toward the rail 16, flattening the curvature of the end cap 22′ until the end cap 22′ is flattened and fits tightly against the rail 16, as shown in FIG. 22. This flattening of the end cap 22′ results in a spring force which helps retain the end cap 22′ on the rail 16.

Referring again to FIGS. 19 and 22, with the end cap 22′ installed onto the rail 16, it may be appreciated that the end cap 22′ lies flat against the end of the rail 16 and no longer displays the slight curvature or slanting away from either of the axes 44 and 47.

FIG. 23 is a section view along line 23-23 of FIG. 16, showing the end cap 22′ mounted on the rail 16. It may be appreciated that there is a projection 54 adjacent the top edge 46′ of the end cap 22′, and intermediate the front and rear edges 48′ of the end cap 22′. This projection 54 provides a support surface for an arcuate plate 56, which is wedged between the two elongated legs 25 of the rail 16 (See FIG. 2) projecting away from the base wall 24 of the rail 16. This arcuate plate 56 spans the opening of the rail 16 so as to cover and hide any mechanism housed inside the rail 16.

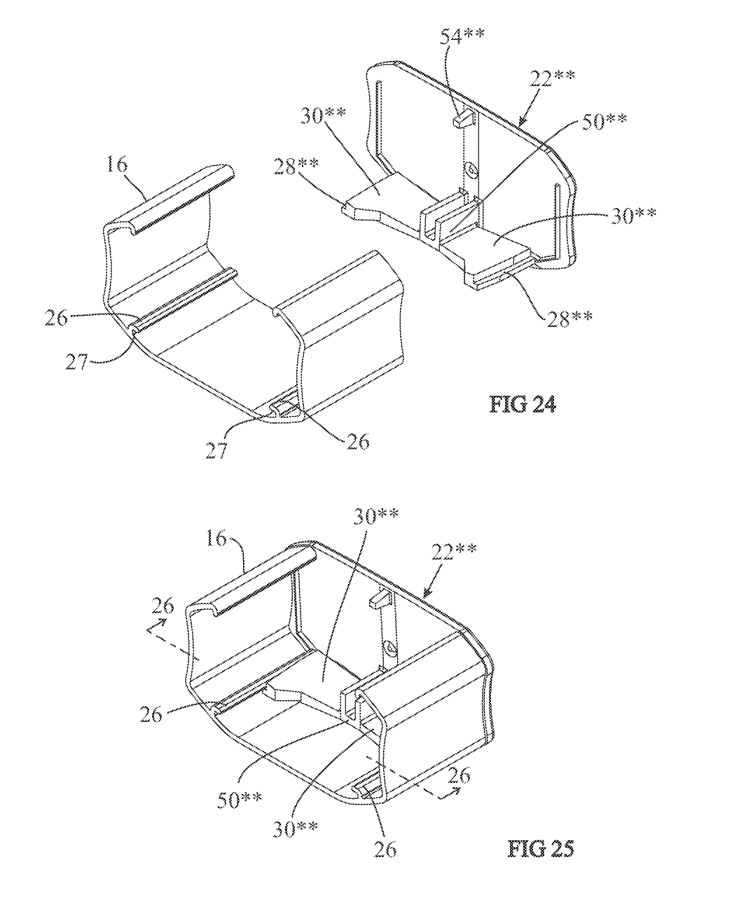

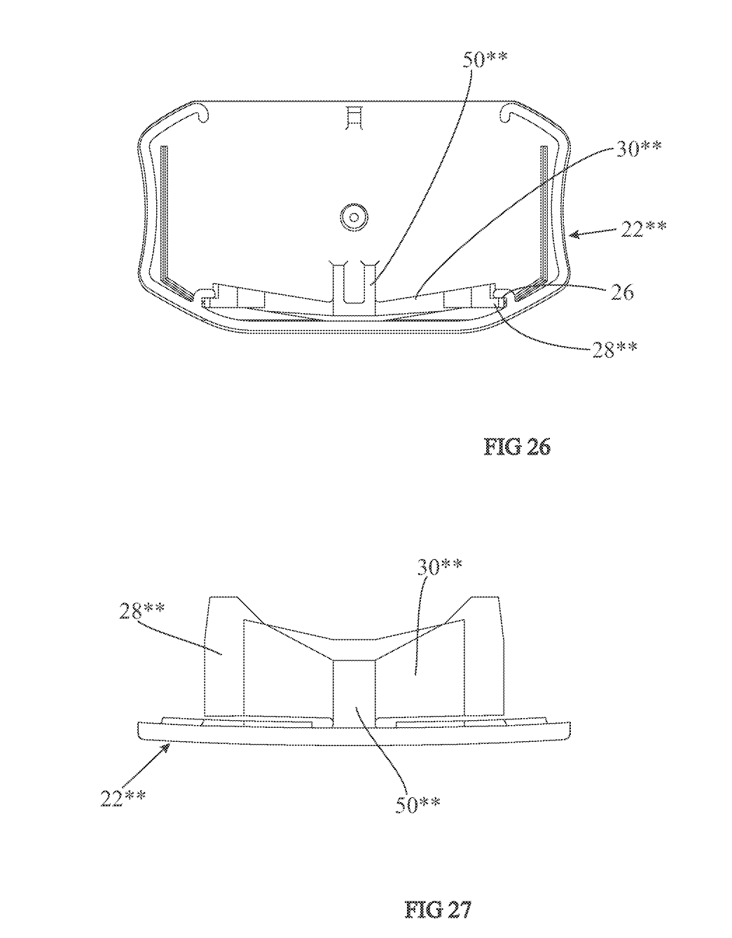

FIGS. 24-30 show other embodiments of an end cap 22** which have a higher holding power than the end cap 22′ described above, and in which the degree of holding power can be fine-tuned as desired. Comparing the end cap 22′ of FIG. 23 with the end cap 22** of FIGS. 24-27 (especially as seen in FIG. 26), it may be appreciated that the beam 50**, outriggers 30** and wings 28** of this end cap 22** forms a more flattened-out, bow-shaped profile as compared with the “M” shaped profile formed by the beam 50, outriggers 30′ and wings 28′ of the previous end cap 22′. As in the previous embodiment, the outriggers 30** are cantilevered from the beam 50**, and the wings 28** are distally mounted on the outriggers 30**.

In the geometry of this embodiment, the end cap 22**moves toward the base of the rail 26 as the end cap 22** is installed onto the rail 26 and the wings 28** are squeezed together (again moving perpendicularly to the squeezing direction). This causes the beam 50** to press against the base of the rail 26. The downward force of the beam 50** against the bottom of the rail, and the counteracting upward force of the wings 28** against the bottom of the track 26 provide additional friction and a higher degree of grip of the end cap 22** on the rail 16 than in the previous end cap 22′.

It should be noted that the amount of movement of the outriggers 30** is very small, and the degree of interference fit of the wings 28** between the tracks 26 and the rail 16 is also very small. However, the spring force provided by the outriggers 30** and the spring force caused by the deformation of the end cap 22** as it is installed on the rail (flattening from the arcuate shape shown in FIG. 20 to a flat shape shown in FIG. 22) allow for numerous removals and reinstallations of the end cap 22** onto the rail 16 without the end cap 22** losing its gripping force on the rail 16. The end cap 22** continues to hold well on the end of the rail 16 even after many removals and reinstallations.

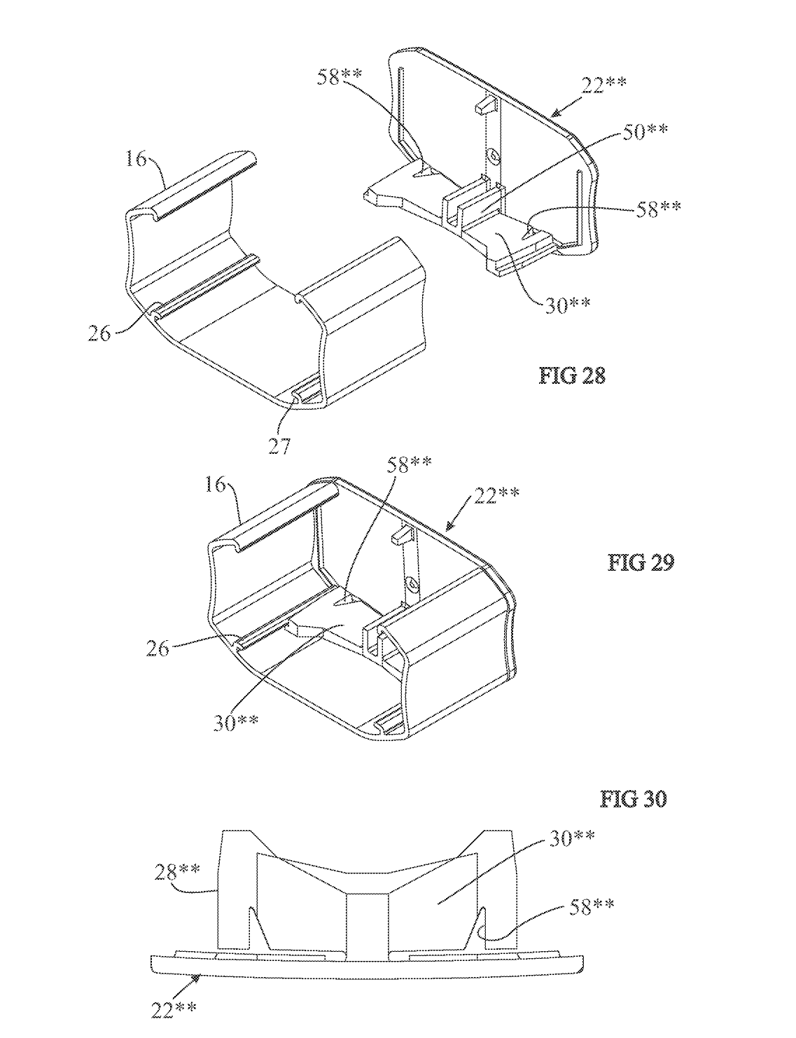

FIGS. 28-30 show a further modification to the end cap 22**. This modification involves cutting out notches 58** from the rear edge of each of the outriggers 30**. These notches 58** allow greater flexing of the rear portion of the wings 28** relative to the beam 50**, which reduces the wedging between the wings 28** and the rail 16. This reduces the degree of holding power between the end cap 22** and the rail 16 as compared with the embodiment of FIGS. 24-27. The amount of holding power can be adjusted by adjusting the length of the notches 58** from the rear edge of the outriggers 30**.

It should be noted that the end cap 22** may be manufactured with the notches 58** already present instead of cutting out these notches 58** off of the end cap 22** of FIGS. 26 and 27. It should also be noted that the length of these notches 58** may be varied from zero (essentially no notches present, as shown in FIGS. 24-27) which maximizes the degree of holding power for this embodiment of the end cap 22**, to whatever length is needed to obtain the desired degree of holding power; the longer the length of the notches 58**, the lower the degree of holding power. Furthermore, there may be a notch 58** in only one of the outriggers 30. Also, while the embodiment of FIG. 28 has identical notches that are mirror images of each other, the notches 58** may have different lengths or have different profiles in order to obtain just the desired amount of holding power. Finally, the notches 58** may be replaced by, or used in conjunction with, changes in thickness of the outriggers 30** adjacent to the wings 28**, providing the wings 28** with more flexibility relative to the beam 50** adjacent to the rear edge of the wings 28** and ultimately reducing the holding power of the end cap 22**.

It is understood that the installation and removal of this end cap 22** is essentially identical to that of the end cap 22′ described earlier.

While the embodiments described above are for an end cap secured to the right end of the rail, it is understood that a mirror image end cap would be used on the left end of the rail.

It will be obvious to those skilled in the art that modifications may be made to the embodiments described above without departing from the scope of the present invention as claimed.

What is claimed is:

1. An arrangement for securing an end cap onto a rail of a covering for an architectural opening, comprising:
an elongated rail extending in a longitudinal direction, having an elongated base wall and elongated legs projecting away from the base wall, said rail defining a flat end;
an end cap, having a slightly arcuate shape when at rest, said end cap including first and second opposed edges and a central portion between said first and second edges, with the first and second edges located closer to the rail than the central portion when at rest; and
a first securement leg which projects inwardly from the end cap and contacts a surface that is fixed relative to the rail to secure the end cap to the rail in a flattened condition, with the first and second edges of the end cap abutting the end of the rail and with the arcuate shape of the end cap flattened out.

2. An arrangement for securing an end cap onto a rail of a covering for an architectural opening as recited in claim 1, wherein said first securement leg has a free end with a projection extending from said free end.

3. An arrangement for securing an end cap onto a rail of a covering for an architectural opening as recited in claim 2, wherein the projection of the first securement leg abuts a retaining wall that is fixed relative to the rail to provide a positive stop that retains the end cap in a flattened condition when the end cap is installed on the rail.

4. An arrangement for securing an end cap onto a rail of a covering for an architectural opening as recited in claim 3, wherein said retaining wall is on an edge of an opening in the base wall of the rail.

5. An arrangement for securing an end cap onto a rail of a covering for an architectural opening as recited in claim 3, wherein said retaining wall is on a body projecting from the rail.

6. An arrangement for securing an end cap onto a rail of a covering for an architectural opening as recited in claim 3, wherein there is a taper on at least one of the projection and the retaining wall so that the first securement leg pulls the end cap further toward the end of the rail as the projection moves further into the retaining wall.

7. An arrangement for securing an end cap onto a rail of a covering for an architectural opening as recited in claim 1, wherein said first securement leg includes a wing which is received in a longitudinal track on said rail, and wherein said wing wedges against the longitudinal track.

8. An arrangement for securing an end cap onto a rail of a covering for an architectural opening as recited in claim 7, wherein there is a second securement leg, with each of said first and second securement legs including a respective wing, and there are two of said longitudinal tracks on said rail, and each of said wings wedges against a respective one of said longitudinal tracks when the end cap is pushed into the rail.

9. An arrangement for securing an end cap onto a rail of a covering for an architectural opening as recited in claim 8, wherein said first and second securement legs are cantilevered off of a third leg projecting inwardly from the end cap between the first and second securement legs.

10. An arrangement for securing an end cap onto a rail of a covering for an architectural opening as recited in claim 9, wherein the third leg has a projection that abuts a retaining wall that is fixed relative to the rail to provide a positive stop that retains the end cap in a flattened condition when the end cap is installed on the rail.

11. An arrangement for securing an end cap onto a rail of a covering for an architectural opening as recited in claim 10, wherein said retaining wall is on an edge of an opening in the base wall of the rail.

12. An arrangement for securing an end cap onto a rail of a covering for an architectural opening as recited in claim 10, wherein said retaining wall is on a body projecting from the rail.

13. An arrangement for securing an end cap onto a rail of a covering for an architectural opening as recited in claim 9, wherein each of said first and second securement legs has a rear edge adjacent to said end cap, and wherein at least one of said first and second securement legs is shaped to provide greater flexibility between the wing and the third securement leg at said rear edge than in other portions of the wing.

14. An arrangement for securing an end cap onto a rail of a covering for an architectural opening as recited in claim 8, wherein said longitudinal tracks lie adjacent to the base of the rail, wherein said end cap has third and fourth opposed edges, said fourth edge lying adjacent to the base of the rail, and wherein the first and second securement legs and respective wings are arranged so that, as the end cap is pushed into the end of the rail, and the wings are pushed into the longitudinal tracks, the third edge of the end cap contacts the rail before the first, second and fourth edges, and, when the end cap is fully assembled onto the end of the rail, all of the first, second, third and fourth edges of the end cap contact the rail.

15. An arrangement for securing an end cap onto a rail of a covering for an architectural opening as recited in claim 14, wherein said first and second securement legs are cantilevered off of a third leg projecting inwardly from the end cap between the first and second securement legs.

16. An arrangement for securing an end cap onto a rail of a covering for an architectural opening as recited in claim 9, wherein said first and second securement legs flex relative to said third leg, and said legs, wings, and rails are arranged such that, as said end cap is pushed onto the end of the rail, and the wings enter their respective tracks, the first and second securement legs are squeezed together in a squeezing direction, which causes the end cap to move relative to the rail in a direction perpendicular to the squeezing direction.

17. An arrangement for securing an end cap onto a rail of a covering for an architectural opening as recited in claim 16, wherein the movement of the end cap in a direction perpendicular to the squeezing direction causes the third leg to move toward and press against the base of the rail.

18. An arrangement for securing an end cap onto a rail of a covering for an architectural opening as recited in claim 16, wherein the movement of the end cap in a direction perpendicular to the squeezing direction causes the third leg to move away from the base of the rail.

19. An arrangement for securing an end cap onto a rail of a covering for an architectural opening as recited in claim 15, wherein said first and second securement legs flex relative to said third leg, and said legs, wings and rails are arranged such that, as said end cap is pushed onto the end of the rail, and the wings enter their respective rails, the first and second securement legs are squeezed together in a squeezing direction, which causes the end cap to move relative to the rail in a direction perpendicular to the squeezing direction.

20. An arrangement for securing an end cap onto a rail of a covering for an architectural opening, comprising:
an elongated rail extending in a longitudinal direction, having an elongated base wall and elongated legs projecting away from the base wall, said rail defining a flat end;
first and second longitudinally-extending tracks projecting inwardly from said elongated rail;
an end cap, having first and second opposed edges and third and fourth opposed edges, said first and second opposed edges lying adjacent to the elongated legs, and the fourth opposed edge lying adjacent to the base wall when the end cap is assembled onto the rail;
first and second securement legs which project inwardly from the end cap and are received in said first and second elongated tracks,
wherein said legs and tracks are arranged such that, as the end cap is pushed into the end of the rail, and the legs are pushed into the longitudinally-extending tracks, the third edge of the end cap contacts the rail before the first, second and fourth edges, and, when the end cap is fully assembled onto the end of the rail, all of the first, second, third and fourth edges of the end cap contact the rail.
